(19) United States
(12) Patent Application Publication
(10) Pub. No.: US 2026/0266515 A1
(43) Pub. Date: Sep. 10, 2026

(54) FLUIDIC CONTROL DEVICE IN PARTICULAR FOR A MAGNETOCALORIC MACHINE, AND MAGNETOCALORIC MACHINE EQUIPPED WITH SUCH A DEVICE

(71) Applicant: MAGNORIC, Duppigheim (FR)

(72) Inventors: Frédéric Marrazzo, Vendenheim (FR); Christian Muller, Strasbourg (FR); Zoé Till, Strasbourg (FR)

(21) Appl. No.: 18/848,014

(22) PCT Filed: Mar. 28, 2023
(86) PCT No.: PCT/EP2023/058035

§ 371 Date: Sep. 17, 2024

(30) Foreign Application Priority Data
Apr. 13, 2022 (FR) FR2203388

(51) Int. Cl. F25B 21/00; F25B 41/20

(52) U.S. Cl. CPC F25B 21/00; F25B 41/20; F25B 2321/0022

(57) ABSTRACT

A fluidic control device for a magnetocaloric machine includes at least one fluidic distributor provided with a slide which is movable between two distribution positions. The control device includes a movable cam cooperating with a follower member integral with the slide of the distributor. The cam is a double-acting cam disposed to displace the follower member in reciprocating translation in one direction and in the opposite direction, corresponding to the two distribution positions of the distributor. The follower member includes a first guide element disposed to move freely in the movable cam, and a second guide element disposed to move freely in a fixed slideway and to guide the follower member in reciprocating translation between said two distribution positions. The guide elements include rollers in order to ensure rolling contact without friction.

### TECHNICAL FIELD

The present invention relates to a fluidic control device, in particular for a magnetocaloric machine comprising at least one fluidic distributor connected to a fluidic circuit, said at least one fluidic distributor comprising a movable slide disposed to be displaced between two distribution positions, said control device comprising a movable cam disposed to cooperate with a follower member, said movable cam being coupled to an actuator, and said follower member being coupled to the movable slide of said fluidic distributor, said movable cam comprising a cam profile provided with at least a first section defining a first distribution position, with a second section defining a second distribution position, and with a transition zone connecting said first section to said second section.

The present invention also relates to a magnetocaloric machine comprising at least one fluidic distributor connected to a fluidic circuit, a magnetic arrangement, a set of active elements based on magnetocaloric material, said magnetic arrangement and said set of active elements being disposed to be movable relative to one another, and a heat transfer fluid disposed in order to circulate in said fluidic circuit through said active elements.

### BACKGROUND

Commercially available fluidic distributors, also termed valves, taps or the like, can be controlled in a known manner between at least two distribution positions by any type of manual, mechanical, electrical, electronic or pneumatic actuators. These distributors may comprise return members, such as compression springs or the like, which make it possible to stress the movable portion of the distributor in a first distribution position, and to effect the return of the movable portion from a second distribution position to the first distribution position automatically. The movable portion of the distributor may be a slide which is movable in translation, a plug which is movable in rotation, or any other equivalent movable member.

In the application encompassed by the invention, which in particular relates to magnetocaloric machines and in particular to magnetic chillers, fluidic distributors, such as those which are available commercially, are used to circulate a heat transfer fluid in a first thermal loop then in a second thermal loop of a fluidic circuit, the switching frequency between the two thermal loops having to be synchronized with the switching frequency of the magnetocaloric cycles of the machine. The fluidic distributors can be controlled by a single-acting movable cam, coupled to a dedicated actuator or to the movable assembly (rotor) of the machine, as described in the publication EP 3 102 893 A1. The movable cam generally has an L-shaped cam profile.

The movable portion of the fluidic distributors in this case is integral with a roller disposed to move on the cam profile, under the action of a prestressed return member. Prestressing the return member generates a force perpendicular to the cam profile, causing significant friction between the roller and the cam. This friction gives rise to numerous disadvantages, such as:
over torquing, and therefore over-consumption at the level of the dedicated actuator or the drive motor for the rotor,
premature wear of the cam, roller and return member,
delaying or even blocking the distributors during the return of the return member to its prestressed position.

However, in the field of magnetocaloric machines, an ongoing objective is to improve the level of performance in order to increase the efficiency of the conversion of thermal energy into work and vice versa depending on the operating mode of the machine. To this end, optimization of the various parameters, such as the intensity and quality of the magnetic field, the performance of the magnetocaloric material, the heat exchange surface area between the heat transfer fluid and the active elements based on magnetocaloric material, the performance of the heat exchangers, etc, is highly sought-after.

The Applicant's publications WO2009/087310 and WO2015/079313 give an appreciation of the technical developments which have already been applied to magnetocaloric machines, which can be further improved.

### SUMMARY OF THE DISCLOSURE

The objective of the present invention is to propose a new avenue for improvement by acting on the fluidic control of this type of machine or others, in order to reduce or even eliminate the interfering forces due to friction between the roller and the cam, thus making it possible to optimize the dedicated actuator and/or the displacement of the rotor with a minimum of torque, to reduce the energy consumption necessary for the operation of the machine, to achieve better control of the transition zone between two distribution cycles and better adjustment of the position of the distributors relative to the cam, generating less wear, and making it possible to obtain a more durable and reliable overall operation of the machine, for optimized performance.

To this end, the invention concerns a fluidic control device of the type indicated in the preamble, characterized in that said cam is a double-acting cam disposed to displace said follower member in reciprocating translation in one direction and in the opposite direction corresponding respectively to said first distribution position and to said second distribution position of said distributor, and in that said follower member comprises a first guide element disposed to move freely in said cam, and a second guide element disposed to move freely in a slideway which is fixed with respect to said at least one distributor, in order to guide said follower member in reciprocating translation between said two distribution positions.

In a preferred embodiment of the invention, the profile of said cam comprises a U-shaped groove disposed to drive said first guide element in both displacement directions.

Preferably, said follower member extends along an axis perpendicular to the axis of the distributor and to the axis of the profile of said cam. It may advantageously comprise two opposed free ends, the first guide element and the second guide element being respectively mounted on said free ends.

The first guide element and/or the second guide element of said follower member may be selected from the group comprising a bearing, a roller, a bearing bush, a shoe, a finger.

The fixed slide may be provided in a mounting part which is integral with said at least one fluidic distributor, and said at least one distributor may comprise adjustment means disposed to adjust the position of its movable slide and of the follower member with respect to said cam.

According to the variational embodiments of the invention, said cam may be circular and driven in continuous rotation, said cam profile in this case being closed on itself. Said cam may also be rectilinear and driven in reciprocating translation, said cam profile in this case being open. In all cases, said cam may be formed from a single part, or from at least two complementary parts in order to facilitate its manufacture and assembly.

To this end as well, the invention concerns a magnetocaloric machine of the type specified in the preamble, characterized in that it comprises a fluidic control device as defined above, coupled to said at least one fluidic distributor and disposed to cause said heat transfer fluid to circulate in a first thermal loop of said fluidic circuit and then in a second thermal loop of said fluidic circuit as a function of a specific switching frequency.

Depending on the variational embodiments of the invention, said fluidic control device may be separate from said magnetic arrangement and from said set of active elements, said cam in this case being coupled to a dedicated actuator. Said fluidic control device may also be integrated into said magnetic arrangement and into said set of active elements, said cam in this case being coupled to a movable assembly of the machine carrying said magnetic arrangement or said set of active elements.

Said magnetocaloric machine may comprise one fluidic distributor per active element disposed to distribute said heat transfer fluid alternately in said first thermal loop and in said second thermal loop, said fluidic control device in this case comprising a cam.

It may also comprise two fluidic distributors per active element, each disposed to distribute said heat transfer fluid in one of said first thermal loop or said second thermal loop, said fluidic control device in this case comprising two parallel cams.

In accordance with the variational embodiments of the invention, said at least one distributor may be disposed axially and parallel to the axis of said dedicated actuator or said movable assembly. It may also be disposed radially and perpendicular to the axis of said dedicated actuator or said movable assembly.

When in the magnetocaloric machine, said movable assembly supports said magnetic arrangement, then said cam may be mounted on said movable assembly, and comprises adjustment means disposed to adjust the relative position of the cam with respect to the magnetic poles of said magnetic arrangement.

### BRIEF DESCRIPTION OF THE DRAWINGS

The present invention and its advantages shall become more clear from the following description of several embodiments given by way of non-limiting example, with reference to the accompanying drawings, in which:

FIG. 1 is a flow chart for a magnetocaloric machine in accordance with the invention,

FIG. 2 is a perspective view of a streamlined magnetocaloric machine, viewed from one of its axial ends comprising radially disposed fluidic distributors cooperating with a fluidic control device in accordance with the prior art,

FIG. 3 is a perspective view of an enlarged portion of the machine of FIG. 2, showing axially disposed fluidic distributors cooperating with a fluidic control device in accordance with the invention,

FIG. 4 is a plan view of an enlarged portion of the machine of FIG. 3,

FIG. 5 is an enlarged axial sectional view of a fluidic control device of the invention associated with a fluidic distributor,

FIG. 6 is a perspective view of a single movable cam forming part of the fluidic control device of the invention,

FIG. 7 is an outline schematic of a first variational embodiment of the fluidic control device in accordance with the invention,

FIG. 8 is an outline schematic of a second variational embodiment of the fluidic control device in accordance with the invention,

FIG. 9 is an outline schematic of a third variational embodiment of the fluidic control device in accordance with the invention, and

FIG. 10 is an outline schematic of a magnetocaloric machine in accordance with a variation of the invention, in which the fluidic distributors and the fluidic control device are separate from the rest of the machine.

### DETAILED DESCRIPTION

In the embodiments shown, elements or portions which are identical have the same reference numerals. Furthermore, the terms having a relative meaning, such as vertical, horizontal, right, left, front, back, above, below, etc. must be interpreted as being under the normal conditions of use of the invention, and as shown in the figures. The X, Y and Z axes are in fact defined by an orthonormal reference system shown in the various figures. Moreover, the geometric positions indicated in the description and the claims, such as “perpendicular”, “parallel”, “symmetrical” are not limited in the strict geometrically defined sense, but extend to geometrical positions which are close, i.e. within a certain tolerance which is acceptable in the technical field in question, without impact on the result obtained. This tolerance is, in particular, introduced by the adverb “substantially”, without this term necessarily being repeated before each adjective.

With reference to the figures, the fluidic control device 10 according to the invention is primarily of interest to magnetocaloric machines 1 for the reasons set out above, but extends to any other technical field in which it is necessary to switch a fluidic circuit at a specific frequency. The term “magnetocaloric machines 1” should be understood to mean both thermal generators, also termed magnetic chillers, converting electrical and/or mechanical energy into thermal energy, used in a wide range of applications, such as heating, cooling, air conditioning, tempering, as well as thermal energy converters, converting into mechanical and/or electrical energy, making it possible in particular to exploit what is known as waste or lost heat, or similar. An example of a reversible magnetocaloric machine is described in particular in the Applicant's publication WO 2021/255040.

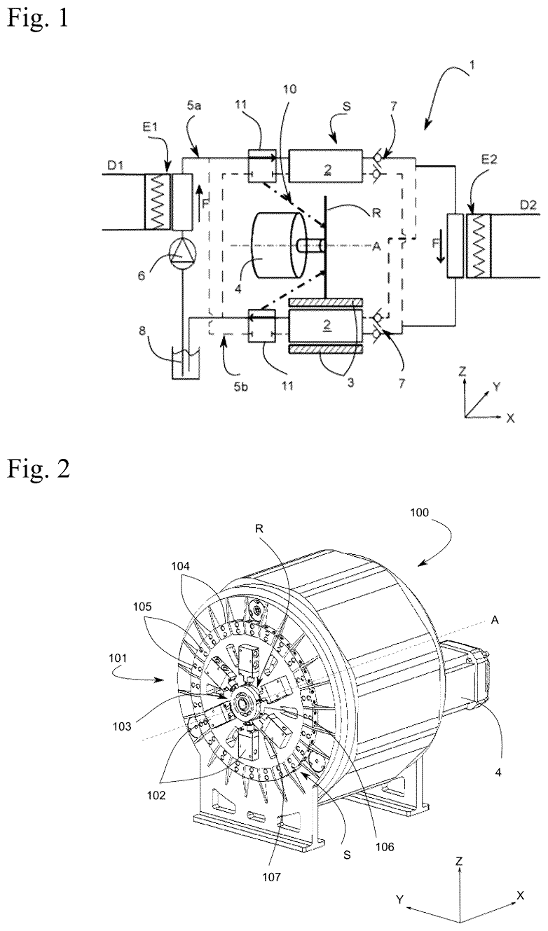

FIG. 1 schematically illustrates the operation of a known magnetocaloric machine 1, described in brief given that it is not the subject of the invention as such. The following description refers to a magnetocaloric machine 1, also termed machine 1, operating as a heat generator. In the example shown, the machine 1 comprises a fixed assembly in the form of a stator S provided with a set of active elements 2 produced from magnetocaloric material (MMC), and a movable assembly in the form of a rotor R provided with a magnetic arrangement forming magnetic poles 3. The rotor R is driven in rotation about an axis A, parallel to the X axis of the orthonormal reference system, by a motor 4 in order to subject the active elements 2 to a magnetic field variation and generate a variation in temperature in the vicinity of their Curie temperature within said active elements 2. Clearly, the reverse configuration exists, in which the set of active elements 2 is carried by a rotor R and the magnetic arrangement 3 by a stator S, but this configuration complicates the connection of the active elements 2 to the fluidic circuit.

In FIG. 1 and solely for the purposes of explaining the operation of the machine 1, only two active elements 2 and only one magnetic pole 3 are shown. The machine 1 comprises an internal fluidic circuit 5 in which a heat transfer fluid circulates via a pump 6 through said active elements 2 and heat exchangers E1 and E2 in order to return the thermal energy produced by the active elements 2 to external devices D1, D2. The heat transfer fluid may be liquid or gaseous, depending on the applications.

The fluidic circuit 5 comprises two thermal loops 5a and 5b of the heat transfer fluid, namely a first thermal loop 5a and a second thermal loop 5b, respectively coupled to a heat exchanger E1, termed the heat exchanger E1, and a heat exchanger E2, termed the cold exchanger E2. The two thermal loops 5a, 5b are connected in parallel by a synchronization system disposed to connect the active elements 2 in series to the heat exchangers E1, E2 alternately in one and the other thermal loops 5a, 5b and to generate alternating thermal cycles at a specific frequency, synchronized with the alternating magnetocaloric cycles induced by the rotation of the rotor R.

The fluidic circuit 5 further comprises members 7 for controlling the direction of circulation of the heat transfer fluid in the thermal loops 5a, 5b in order to impose a single direction of circulation of the heat transfer fluid in the heat exchangers E1, E2, illustrated by the arrows F. It may also comprise a buffer reservoir 8 of heat transfer fluid connected in series with each of the thermal loops 5a, 5b in order to compensate for any losses of heat transfer fluid and/or variations in volumes of the heat transfer fluid as a function of the temperature.

The operation of the machine 1 shall be briefly described with reference to FIG. 1. In a first thermal cycle, the fluidic distributors 11 are in a first distribution position, as illustrated in FIG. 1, and the heat transfer fluid circulates in a clockwise direction in a first thermal loop 5a, shown in solid lines. It passes through the active element 2 located at the bottom of FIG. 1, which undergoes a heating cycle, being located in the magnetic field of one of the magnetic poles 3 of the rotor R, passes through the hot exchanger E1, where it returns the collected heat to an external device D1, then passes through the active element 2 located at the top of FIG. 1, which undergoes a cooling cycle, being located outside the magnetic field, passes through the cold exchanger E2, where it returns the collected cold to an external device D2.

In a second thermal cycle, the fluidic distributors 11 are in a second distribution position, not illustrated in FIG. 1, and the heat transfer fluid circulates in the anticlockwise direction in a second thermal loop 5b shown as a short, dashed line. It passes through the active element 2 located at the bottom of FIG. 1, which now undergoes a cooling cycle, being located outside the magnetic field (not shown), passes through the cold exchanger E2 where it returns the collected cold to an external device D2, then passes through the active element 4 located at the top of FIG. 1, which now undergoes a heating cycle, being located in the magnetic field of one of the magnetic poles 3 of the rotor R, passes through the hot exchanger E1, where it returns the collected heat to an external device D1.

The first and second thermal cycles are repeated because of the synchronization system which comprises fluidic distributors 11 controlled in accordance with a switching frequency specified by a fluidic control device 10, which is the subject matter of the invention and described below.

The magnetocaloric machine 1 as represented in FIG. 1 and in the other figures is described according to a cylindrical configuration in which the rotor R is driven in a continuous rotational movement, without this example being limiting. In fact, a magnetocaloric machine 1 with a linear configuration is entirely conceivable, in which the stator S and the rotor R are flattened, and the rotor R is driven with an alternating translational movement.

More particularly in FIG. 2, the magnetocaloric machine 100 comprises radially disposed fluidic distributors 102 at one of its axial ends 101, cooperating with a fluidic control device 103 as described in the Applicant's publication WO 2021/255040. The machine 100 comprises active elements (not visible) supported by a material support 104 forming a stator S, provided with fluidic connections 105 which are accessible from the axial end shown. The fluidic connections 105 comprise at least one fluid inlet and one fluid outlet per active element. The pipework for connecting the fluidic connections 105 to the distributors 102 is not shown, so as not to overload the figure.

The fluidic distributors 102 are slide valves in the example shown. The fluidic control device 103 comprises a movable cam 106 and follower rollers 107 disposed to move on the cam 106. The cam 106 is coupled to an actuator which may be a dedicated actuator 20 (FIG. 10) or the actuator of rotor R of the machine 100, namely the motor 4 as shown (FIGS. 1 and 2). In the case of a dedicated actuator 20, a control unit (not shown) is provided to synchronize the operation of the dedicated actuator 20 of the cam 106 with the motor 4 of the rotor R, in the case of a magnetic chiller. In this example, the cam 106 comprises a single-acting cam profile, i.e. active in only one displacement direction. In this case, the cam profile has an L-shaped section. Furthermore, the follower rollers 107 are secured to the slides (not visible) of the distributors 102 and the distributors 102 comprise prestressed return members (not visible) which secure the follower rollers 107 against the cam profile, necessarily generating significant friction between the roller 107 and the cam 106, which is to be avoided.

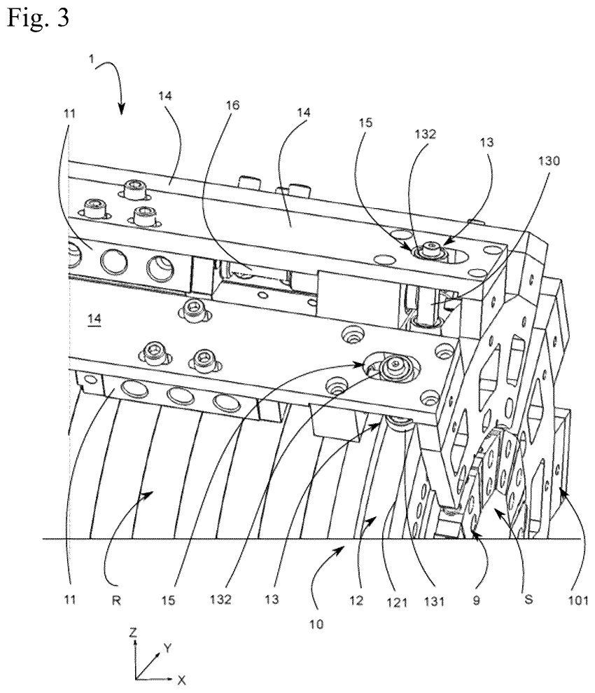

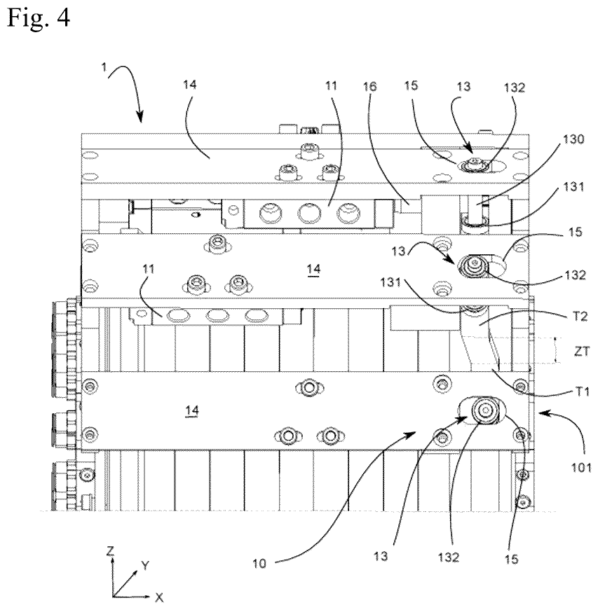

With reference now to FIGS. 3 to 6, the fluidic distributors 11 according to the invention, also termed distributors 11, are preferably slide valves, in which the slide (not shown) is movable in reciprocating translation between two distribution positions, freely, without any prestress, or return member, in order to open and close inlet and outlet orifices of the distributors as a function of a specified distribution scheme. To this end, the fluidic control device 10 in accordance with the invention, also termed the control device 10, comprises a movable cam 12, also termed cam 12, having a double-acting cam profile, i.e. active in the two opposed displacement directions. In this case, the cam profile has a U-shaped section. In the example shown, the movable cam 12 is directly integral with the rotor R of the machine 1 and cooperates with a follower member 13 which is integral with the slide of the fluidic distributors 11. Clearly, the movable cam 12 could also be coupled to a dedicated actuator 20, as shown in FIG. 10.

The cam 12 is shown in detail in FIG. 6. It comprises a ring 120, the axis of revolution of which is intended to coincide with the axis A of the rotor R, provided with a circular groove 121 in its outer periphery, open radially along the Z axis and extending along the Y axis. The groove 121 defines a U-shaped cam profile, and in the example shown comprises two diametrically opposed first sections T1, defining a first distribution position, two diametrically opposed second sections T2, defining a second distribution position, alternating with the first sections T1, and four transition zones ZT each connecting a first section T1 to an adjacent second section T2. Thus, the number of pairs of sections T1+T2 provided in the cam 12 corresponds to the number of magnetic poles 3 of the machine 1. The cam 12 can therefore comprise one pair of sections T1+T2 if the machine 1 comprises a single magnetic pole 3, and more than two pairs of sections T1+T2 if the machine 1 comprises more than two magnetic poles 3. The sections T1 and T2 are rectilinear, parallel to the Y axis and therefore perpendicular to the X axis. The first sections T1 and the second sections T2 are offset from each other by a travel C corresponding to the travel of the movable slides of the distributors 11 between two distribution positions. Finally, the transition zones ZT are inclined with respect to the Y axis in order to ensure the continuity of the cam profile between the different sections T1 and T2. The angle of inclination of the transition zones ZT is determined in order to reduce the switching time as much as possible, but without penalizing the continuous movement of the follower member 13 in the groove 121. This angle may be between 10° and 60°, without these values being limiting.

The cam 12 also comprises a mounting flange 122 on its inner periphery, perforated with a plurality of mounting holes 123. The cam 12 is provided so as to be mounted directly and securely on the movable assembly of the machine 1. In the example shown, the movable assembly of the machine 1 comprises two coaxial rotors R, namely an inner rotor and an outer rotor, between which the fixed assembly forming a stator S carrying the active elements is disposed. In this example, the movable cam 12 is mounted on the outer rotor R, shown very partially by its outer casing in the figures. The plurality of fixing holes 123 form means for adjusting the angular position of the cam 12 with respect to the magnetic poles 3 carried by the rotors R. In fact, each first section T1 of the cam 12 must be aligned with one of the magnetic poles 3, and each second section T2 of the cam 12 must be aligned with the empty or non-magnetic zone separating two magnetic poles 3, or vice versa. Thus, each section T1 and T2 arranged in the cam 12 corresponds exactly to a working cycle of the machine, which corresponds in this specific application to one magnetocaloric heating cycle and one magnetocaloric cooling cycle. The movable cam 12 is illustrated in the form of a single part, but may of course be formed by two complementary parts, each corresponding to a half-ring, or by more than two complementary parts, each corresponding to an annular sector, said parts possibly being identical or not identical, in order to facilitate its manufacture and mounting it on the rotor R.

In the example shown in FIGS. 3 to 5, the fluidic distributors 11 are disposed axially, i.e. parallel to the axis A of the rotor R or the X axis of the orthonormal reference system, and perpendicular to the Y axis of the cam 12. They are represented by parallelepipedal blocks provided with inlet orifices on one side and outlet orifices on the opposite side. In this example, they may be 5/2-way, 4/2-way or similar valves, each of which ensuring the distribution of the heat transfer fluid in the two thermal loops 5a, 5b of the fluidic circuit 5. In this case, the machine 1 comprises a number of fluidic distributors 11, equal to the number of active elements 2. The distributors 11 may also comprise 4/2-way, 3/2-way or similar valves, which can each ensure the distribution of the heat transfer fluid in only one of the two thermal loops 5a, 5b of the fluidic circuit 5, thus avoiding mixing of the heat transfer fluid in the transition zones ZT during the switching phases. In this case, the number of 3/2 or 4/2 distributors required for the same machine 1 is double the number of 5/2 distributors.

The distributors 11 are mounted on a fixed assembly of the machine 1, such as the material support 9 of the stator S, each by means of a mounting part 14 which extends axially in the X axis, extends at least on one side of the distributors 11 to straddle the cam 12, and then extends radially in the Z axis to the material support 9. The mounting part 14 further comprises, in line with the cam 12, a slideway 15, formed in the example shown by an oblong slot on the X axis, and with a length which is at least equal to the travel C of the slide. The slide of each distributor 11 is extended by a control rod 16 carrying a follower member 13 at its free end. Each distributor 11 may furthermore comprise an adjustment means, for example in the form of a screw and nut system or the like, making it possible to adjust the relative position of the follower member 13 with respect to the cam 12, and simultaneously the relative position of the slide with respect to the inlet and outlet orifices of the distributor 11.

The follower member 13 forms part of the fluidic control device 10 of the invention and cooperates with the movable cam 12 which generates its reciprocating translational movement in the X axis in one direction and in the opposite direction, respectively corresponding to a first distribution position and to a second distribution position of the distributor 11. In this example, the control rod 16 of the slide is T-shaped, the bar of the T forming the follower member 13. Thus, the follower member 13 extends along the Z axis perpendicular to the X axis of the distributor 11 and to the Y axis of the cam 12.

The follower member 13 comprises a rectilinear bar 130, having two opposed free ends, respectively carrying a first guide element 131 and a second guide element 132. The first guide element 131 is disposed to move freely in the groove 121 of the cam 12 along the Y axis. The second guide element 132 is disposed to move freely in the slideway 15 of the mounting part 14 of the distributors 11 along the X axis, and therefore to guide the follower member 13 in reciprocating translation between the two positions of the distributor 11, eliminating its other degrees of freedom, and in particular its rotation about the X axis of the distributor 11. In the example shown, the guide elements 131, 132 are constituted by bearings, but could be constituted by rollers, bearing bushes, shoes, fingers, or any other rotating or sliding member, the key aspect being to create a rolling or low coefficient of friction contact respectively with the cam 12 and the slideway 15 in order to reduce or even eliminate friction. It is also possible to add lubrication and to enclose the control device 10 in a casing containing said lubricant.

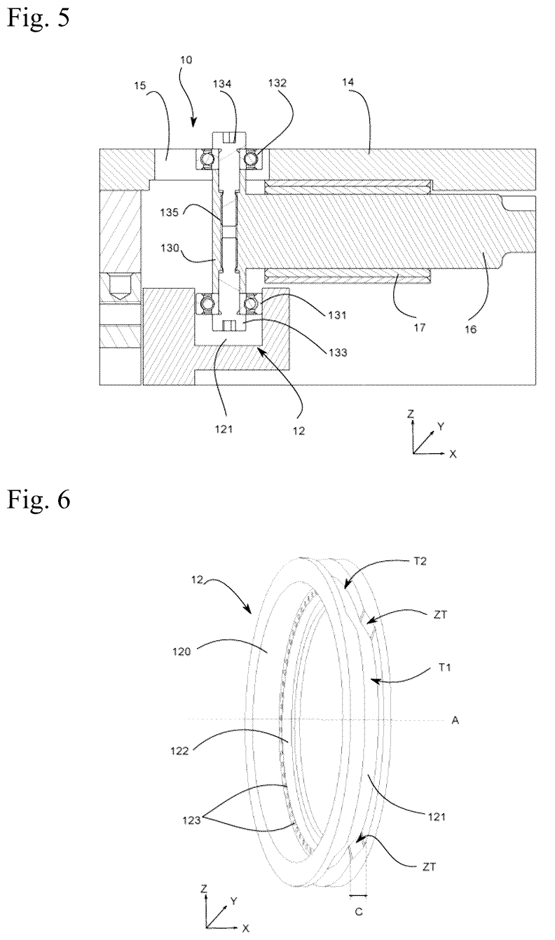

FIG. 5 shows the construction of the follower member 13 in detail. The bearings respectively forming the first guide element 131 and the second guide element 132 are attached to the free ends of the bar 130 and mounted in a tapped bore 135 by means of mounting screws 133, 134. The bar 130 may be an integral part of the control rod 16, or it may be attached. Clearly, any other equivalent embodiment of the follower member 13 may be suitable. This FIG. 5 also shows a guide ring 17 disposed to guide the control rod 16 of the distributor slide in translation, attached to the mounting part 14, or to the control rod 16, or to both in the case of a double guide ring.

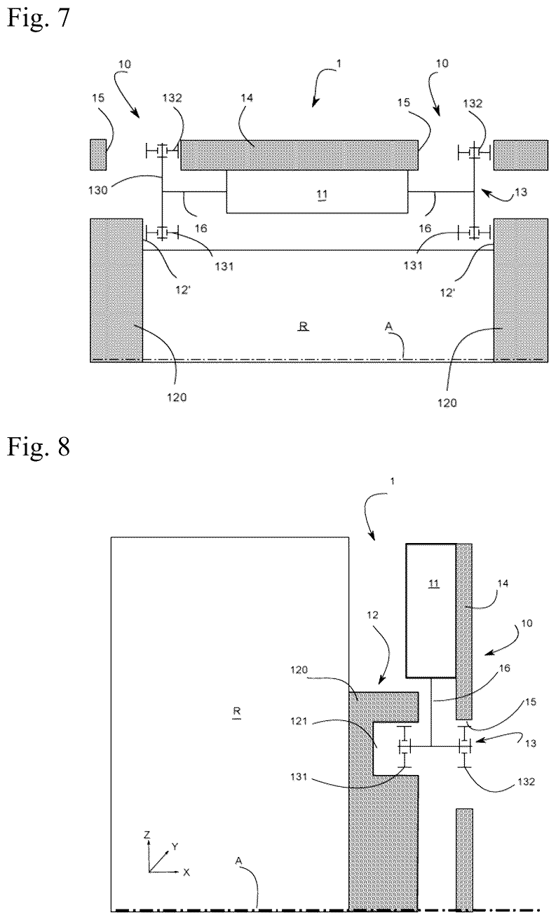

In FIGS. 3 to 5, for each active element 2, the machine 1 comprises an axially disposed fluidic distributor 11 which is controlled by a single movable cam 12 disposed at one of the axial ends of the machine 1. This example of construction is not the only one, and FIGS. 7 to 9 schematically illustrate other examples of construction of the fluidic control device 10 in accordance with the invention.

FIG. 7 shows an axially disposed fluidic distributor 11 supported by a mounting part 14, and controlled by two single-acting cams 12′ disposed in opposition in the two axial ends of the machine 1. The two single-acting cams 12′ are equivalent to the double-acting cam 12 described above. In this example, the distributor 11 comprises two aligned control rods 16, connected to the two opposite ends of its slide, and each carrying a follower member 13 cooperating with one of the cams 12′ at its free end. This type of mounting makes it possible to balance the guiding and control forces of the fluidic distribution system. In this variation, the single fluidic distributor 11 per active element 2 is a 5/2-way or 4/2-way valve. In a variation which is not shown, the single fluidic distributor 11 may be replaced by two distributors in the form of 3/2-way or 4/2-way valves, connected to each other and each controlled by one of the two cams 12′.

FIG. 8 shows a fluidic distributor 11 disposed radially along the Z axis, in one of the axial ends of the machine 1, and controlled by a single cam 12 disposed in said axial end, open axially in the X axis. In this example, the distributor 11 is a 5/2-way valve, the control rod 16 of the slide extends in the Z axis and the follower member 13 extends in the X axis.

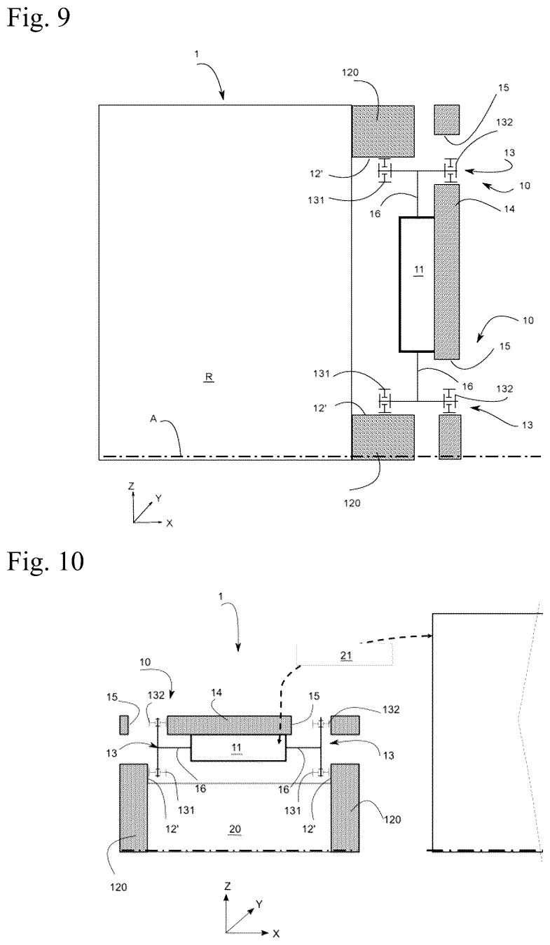

FIG. 9 shows a similar arrangement to FIG. 8, in which the fluidic distributor 11 is disposed radially along the Z axis but controlled by two opposing single-acting cams 12′, as in FIG. 7. In this variation, the single fluidic distributor 11 per active element 2 is a 5/2-way or 4/2-way valve. In a variation which is not shown, the single fluidic distributor 11 may be replaced by two distributors in the form of 3/2-way or 4/2-way valves, each controlled by one of the two cams 12′.

FIG. 10 shows a magnetocaloric machine 1 in accordance with a variational embodiment of the invention, in which the fluidic distributors 11 and the fluidic control device 10 are separate from the rest of the machine, which in particular comprises the set of active elements 2 and the magnetic arrangement 3, one carried by a stator S and the other by a rotor R. In this configuration, the cam 12 is coupled to a dedicated actuator 20 such as a motor, and is guided in rotation in a fixed support (not shown). The fluidic distributors 11 themselves are connected to said fixed support by their mounting parts 14. The fluidic distributors 11 are furthermore connected to the active elements 2 by appropriate fluidic conduits 21.

The dedicated actuator 20 may be controlled by a control unit (not shown) provided to synchronize the operation of the dedicated actuator 20 of the cam 12 with that of the rotor R, in particular when the magnetocaloric machine 1 operates as a magnetic chiller. This is not the case when the magnetocaloric machine 1 operates as a thermal converter disposed to recover thermal energy from lost waste heat, since it is the fluidic control device 10 that induces the rotation of the rotor R. In this mode of operation, the rotor R may be coupled to an electrical generator in order to produce electrical energy.

The fluidic control device 10 shown in FIG. 10 corresponds to that shown in FIG. 7, namely that the fluidic distributors 11 are positioned axially and controlled by two single-acting cams 12′ disposed in opposition. Clearly, the other radial arrangements illustrated in FIGS. 8 and 9 may also be adapted to this variational embodiment, as well as any other compatible configuration.

The present invention is clearly not limited to the exemplary embodiments described, but encompasses all modifications and variations which are obvious to a person skilled in the art within the scope of the accompanying claims. Furthermore, the technical features of the various embodiments and variations mentioned above can be combined in their entirety or only in part.

1. A fluidic control device, in particular for a magnetocaloric machine comprising at least one fluidic distributor connected to a fluidic circuit, said at least one fluidic distributor comprising a movable slide disposed to be displaced between two distribution positions, said control device comprising a movable cam disposed to cooperate with a follower member, said cam being coupled to an actuator, and said follower member being coupled to the slide of said distributor, said cam comprising a cam profile provided with at least a first section defining a first distribution position, with a second section defining a second distribution position, and with a transition zone connecting said first section to said second section, the control device being wherein said cam is a double-acting cam disposed to displace said follower member in reciprocating translation in one direction and in the opposite direction respectively corresponding to said first distribution position and to said second distribution position of said distributor, and wherein said follower member comprises a first guide element disposed to move freely in said cam, and a second guide element disposed to move freely in a slideway which is fixed with respect to said at least one distributor, in order to guide said follower member in reciprocating translation between said two distribution positions.

2. The fluidic control device as claimed in claim 1, wherein the profile of said cam comprises a U-shaped groove disposed to drive said first guide element in both displacement directions.

3. The fluidic control device as claimed in claim 1, wherein said follower member extends along an axis perpendicular to the axis of the distributor and to the axis of the profile of said cam.

4. The fluidic control device as claimed in claim 1, wherein said follower member comprises two opposed free ends, and wherein the first guide element and the second guide element are respectively mounted on said free ends.

5. The fluidic control device as claimed in claim 1, wherein the first guide element and/or the second guide element of said follower member is selected from the group comprising a bearing, a roller, a bearing bush, a shoe, a finger.

6. The fluidic control device as claimed in claim 1, wherein the fixed slideway is provided in a mounting part which is integral with said at least one fluidic distributor, and wherein said at least one distributor comprises adjustment means disposed to adjust the position of a movable slide of said at least one distributor and of the follower member with respect to said cam.

7. The fluidic control device as claimed in claim 1, wherein said cam is circular and driven in continuous rotation, and wherein said cam profile is closed on itself.

8. The fluidic control device as claimed in claim 1, wherein said cam is rectilinear and driven in reciprocating translation, and wherein said cam profile is open.

9. The fluidic control device as claimed in claim 1, wherein said cam is formed by a single part, or by at least two complementary parts.

10. A magnetocaloric machine comprising at least one fluidic distributor connected to a fluidic circuit, a magnetic arrangement, a set of active elements based on magnetocaloric material, said magnetic arrangement and said set of active elements being disposed to be movable relative to each other, and a heat transfer fluid disposed to circulate in said fluidic circuit through said active elements, and further comprising a fluidic control device as claimed in claim 1, coupled to said at least one fluidic distributor and disposed to cause said heat transfer fluid to circulate in a first thermal loop of said fluidic circuit then in a second thermal loop of said fluidic circuit as a function of a specific switching frequency.

11. The magnetocaloric machine as claimed in claim 10, wherein said fluidic control device is separate from said magnetic arrangement and from said set of active elements, and wherein said cam is coupled to a dedicated actuator.

12. The magnetocaloric machine as claimed in claim 10, wherein said fluidic control device is integrated into said magnetic arrangement and into said set of active elements, and wherein said cam is coupled to a movable assembly of the machine carrying said magnetic arrangement or said set of active elements.

13. The magnetocaloric machine as claimed in claim 10, further comprising one distributor per active element disposed to distribute said heat transfer fluid alternately in said first thermal loop and in said second thermal loop, and wherein said fluidic control device comprises a cam.

14. The magnetocaloric machine as claimed in claim 10. further comprising two distributors per active element each disposed to distribute said heat transfer fluid in one of said first thermal loop or said second thermal loop, and wherein said fluidic control device comprises two parallel cams.

15. The magnetocaloric machine as claimed in claim 12, wherein said at least one distributor is disposed axially and parallel to the axis of said dedicated actuator or said movable assembly.

16. The magnetocaloric machine as claimed in claim 12, wherein said at least one distributor is disposed radially and perpendicular to the axis of said dedicated actuator or said movable assembly.

17. The magnetocaloric machine as claimed in claim 12, in which said movable assembly supports said magnetic arrangement, wherein said cam is mounted on said movable assembly, and wherein said cam comprises adjustment means disposed to adjust the relative position of the cam with respect to the magnetic poles of said magnetic arrangement.
